(19) United States
(12) Patent Application Publication
(10) Pub. No.: US 2025/0188760 A1
(43) Pub. Date: Jun. 12, 2025

(54) AUTOMATIC VALVE FOR SWIMMING POOL CIRCULATION SYSTEM

(71) Applicant: ZODIAC POOL CARE EUROPE, Belberaud (FR)

(72) Inventor: Matthieu Bellec, Montesquieu Lauragais (FR)

(73) Assignee: ZODIAC POOL CARE EUROPE, Belberaud (FR)

(21) Appl. No.: 18/971,716

(22) Filed: Dec. 6, 2024

Related U.S. Application Data
(60) Provisional application No. 63/607,217, filed on Dec. 7, 2023.

(51) Int. Cl. E04H 4/12

(52) U.S. Cl. CPC E04H 4/12

(57) ABSTRACT

A method for optimizing a flow of water of a swimming pool or spa includes monitoring a parameter associated with performance of a first piece of equipment of the swimming pool or spa, such as but not limited to a heat pump, and relative to a target for the parameter. The method includes activating a bypass valve such that water bypasses the first piece equipment based on the parameter reaching or exceeding the target. The method includes controlling operation of a second piece of equipment of a circulation system responsive to activation of the bypass valve.

### REFERENCE TO RELATED APPLICATION

This application claims the benefit of and priority to U.S. Provisional Patent Application No. 63/607,217, filed on Dec. 7, 2023, and entitled AUTOMATIC VALVE FOR SWIMMING POOL CIRCULATION SYSTEM, the content of which is hereby incorporated by reference in its entirety.

### FIELD OF THE INVENTION

The invention relates to systems and apparatuses for swimming pools and spas, and more particularly, although not necessarily exclusively, to an automatic valve for a circulation system for a swimming pool or spa.

### BACKGROUND OF THE INVENTION

Water of a swimming pool or spa may be circulated through a circulation system, which may include various equipment for performing operations related to the water. As non-limiting examples, a circulation system may have a skimmer for drawing water into the circulation system, a pump for circulating water, a filtration system for removing debris or other particulates from the water, a heater for heating water of the swimming pool spa, a water treatment system for cleaning and treating filtered water, and/or other equipment as desired. Some equipment such as the heater may cause a reduction in flow of water and/or may require increased pumping performance (and thus increased energy usage) to maintain a same flow rate, thereby making such equipment expensive or energy-intensive to use.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a method of optimizing a flow of water of a swimming pool or spa includes monitoring a temperature of water of the swimming pool or spa relative to a target temperature, activating a bypass valve such that water bypasses a heat pump for the swimming pool or spa based on the temperature of the water reaching or exceeding the target temperature, and controlling a filtration pump upon activation of the bypass valve by reducing a water filtration time or reducing a speed of the filtration pump.

According to some embodiments, a method of optimizing a flow of water of a swimming pool or spa includes monitoring a temperature of water of the swimming pool or spa relative to a target temperature, activating a bypass valve such that water bypasses a heat pump for the swimming pool or spa based on the temperature of the water reaching or exceeding the target temperature, and controlling a filtration pump upon activation of the bypass valve to reduce energy consumption.

According to various embodiments, a method of optimizing a flow of water of a swimming pool or spa includes receiving a flow rate of water through a circulation system and when a heat pump is heating the water, monitoring a temperature of the water of the swimming pool or spa relative to a target temperature, activating a bypass valve such that the water bypasses the heat pump for the swimming pool or spa based on the temperature of the water reaching or exceeding the target temperature, and controlling a filtration pump upon activation of the bypass valve to maintain the flow rate through the circulation system.

According to some embodiments, a method of optimizing a flow of water of a swimming pool or spa includes monitoring a parameter associated with performance of equipment of the swimming pool or spa and relative to a target for the parameter, activating a bypass valve such that water bypasses the equipment based on the parameter reaching or exceeding the target, and controlling a filtration pump upon activation of the bypass valve by reducing a water filtration time or reducing a speed of the filtration pump.

According to certain embodiments, a method of optimizing a flow of water of a swimming pool or spa includes monitoring a parameter associated with performance of equipment of the swimming pool or spa and relative to a target for the parameter, activating a bypass valve such that water bypasses the equipment based on the parameter reaching or exceeding the target, and controlling a pump and/or a filtration system upon activation of the bypass valve to reduce energy consumption.

According to various embodiments, a method of optimizing a flow of water of a swimming pool or spa includes monitoring a parameter associated with performance of equipment of the swimming pool or spa and relative to a target for the parameter, activating a bypass valve such that water bypasses the equipment based on the parameter reaching or exceeding the target, and controlling a pump and/or a filtration system upon activation of the bypass valve to maintain a flow rate through the circulation system.

According to some embodiments, a method of optimizing a flow of water of a swimming pool or spa includes directing water to a heat pump, monitoring a temperature of water of the swimming pool or spa relative to a target temperature using a sensor within the heat pump, and activating a bypass valve based on the temperature of the water reaching or exceeding the target temperature, wherein activating the bypass valve causes a majority of a flow of water to bypass the heat pump while maintaining a minimum flow of water to the heat pump.

According to some embodiments, a method of controlling ice formation on a heat pump includes increasing a pressure of refrigerant of the heat pump by decreasing a flow of water through the heat pump, wherein decreasing the flow of water comprises controlling a bypass valve for the heat pump.

According to certain embodiments, a pool system includes a heat pump and an automatic valve, wherein the automatic valve is actuatable in response to a temperature of water of the water-containing vessel to adjust a flow of water through the heat pump.

According to various embodiments, a pool system include a heat pump, a temperature sensor within the heat pump, and an automatic valve. The automatic valve is controllable to optimize flow of water through the heat pump to optimize energy consumption of the pool system based at least in part on temperature data about the water gathered by the temperature sensor.

According to some embodiments, a method of optimizing a flow of water of a swimming pool or spa includes monitoring a parameter associated with performance of a first piece of equipment of the swimming pool or spa and relative to a target for the parameter, activating a bypass valve such that water bypasses the first piece equipment based on the parameter reaching or exceeding the target, and controlling operation of a second piece of equipment of a circulation system responsive to activation of the bypass valve.

According to various embodiments, non-transitory computer readable storage medium comprising a plurality of instructions executable by one or more processors, the plurality of instructions comprising instructions which, when executed by the one or more processors, cause the one or more processors to perform actions including monitoring a parameter associated with performance of a first piece of equipment of the swimming pool or spa and relative to a target for the parameter, activating a bypass valve such that water bypasses the first piece equipment based on the parameter reaching or exceeding the target, and controlling operation of a second piece of equipment of a circulation system responsive to activation of the bypass valve

According to certain embodiments, a pool system includes a circulation system with a bypass valve for controlling a flow of water relative to a first piece of equipment and a controller configured to receive sensor data from at least one sensor, the sensor data comprising a parameter associated with performance of the first piece of equipment of the pool system, compare the parameter relative to a target for the parameter, responsive to the parameter reaching or exceeding the target, activating the bypass valve such that the flow of water bypassing the first piece of equipment is greater than the flow of water to the first piece of equipment, and responsive to activating the bypass valve, controlling operation of a second piece of equipment of the circulation system.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 illustrates a pool system according to embodiments.

FIG. 2 illustrates the pool system of FIG. 1 in a first operating configuration.

FIG. 3 is a graph illustrating water flow in the first operating configuration of FIG. 2.

FIG. 4 illustrates the pool system of FIG. 1 in a second operating configuration.

FIG. 5 is a graph illustrating water flow in the first operating configuration of FIG. 4.

### DETAILED DESCRIPTION

Described herein are systems and methods for optimizing a flow of water for a swimming pool or spa using an automatic valve. In certain embodiments, the systems and methods described herein may selectively activate the automatic valve to bypass equipment for the swimming pool or spa based on the equipment completing a task (e.g., a parameter reaches a target). As a non-limiting example, the automatic valve may be activated to cause the flow of water to bypass a heat pump or heater based on a temperature of the water reaching a target temperature. Other non-limiting examples of equipment that may be selectively bypassed include, but are not limited to, filtration pumps, sand filtration systems, water features (e.g., fountains, jets, etc.), water treatment systems, combinations thereof, and/or other equipment as desired.

In certain embodiments, the systems and methods described herein may optimize the flow of water by controlling equipment to reduce energy consumption and/or to maintain a flow rate of the water. As non-limiting examples, the systems and methods described herein may reduce a water filtration time and/or reduce a speed of a pump upon activation of the bypass valve to reduce energy consumption and/or to maintain the flow rate of water.

In some non-limiting examples, the systems and methods described herein may provide a positive impact on pressure within a heat pump by increasing refrigerant pressure of the heat pump by reducing water flow, thereby providing improved control against icing. In certain embodiments, the systems and methods described herein with the automatic valve may allow for improved backwashing and/or a plurality water flow inputs and/or outputs. In some embodiments, the systems and methods described herein may provide both energy savings and cost savings to a user of the swimming pool or spa.

Various other benefits and advantages may be realized with the systems and methods provided herein, and the aforementioned advantages should not be considered limiting.

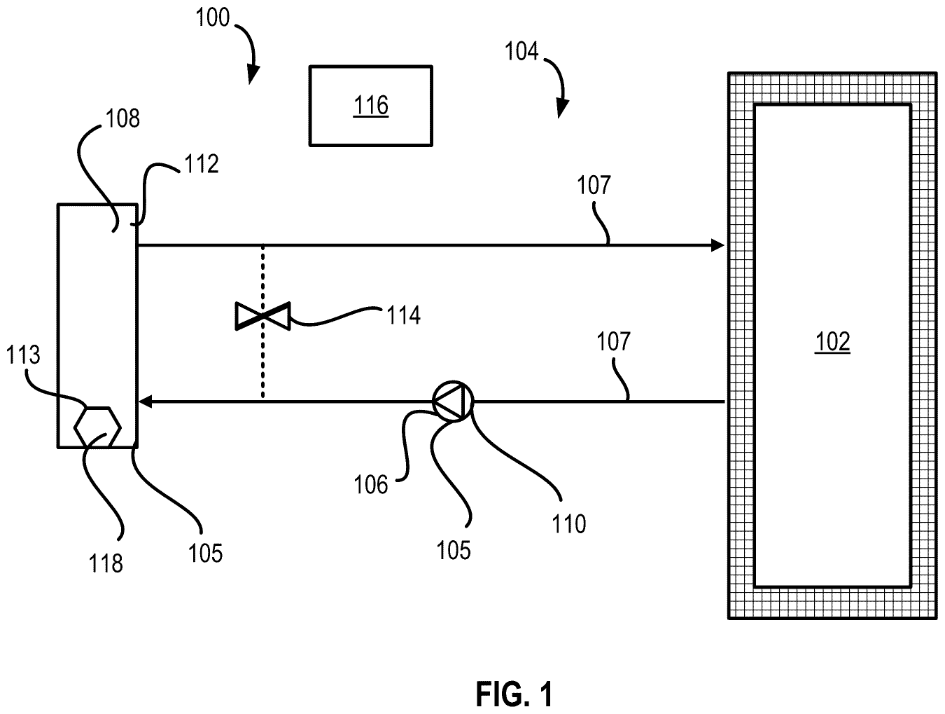

FIGS. 1, 2, and 4 illustrate an example of a pool system 100 with a pool 102 and a circulation system 104 according to embodiments. Referring to FIG. 1, the circulation system 104 circulates water to the pool 102 (represented by arrows 107) and may include various equipment 105 for performing various operations. Non-limiting examples of equipment 105 of the circulation system 104 may include, but are not limited to, one or more skimmers, one or more filtration systems or filters, sand filtration systems, one or more pumps 106, one or more heaters 108, one or more sanitation systems, one or more water features (e.g., fountains, jets, etc.), sub-combinations thereof, and/or other equipment as desired. In FIGS. 1, 2, and 4, the equipment 105 includes one or more pumps 106 and one or more heaters 108, although other equipment 105 and/or combinations of equipment 105 may be utilized as desired.

In certain embodiments, the circulation system 104 includes at least one pump 106 and at least one heater 108. The pump 106 may control a flow rate of water flowing through the circulation system 104 back to the pool 102 and may be various types of pumps 106. In one non-limiting example, the pump 106 may be a filtration pump 110. In certain embodiments, the pump 106 may be a variable speed pump operable in various modes such that the water may flow at various flow rates. The heater 108 may control a temperature of water flowing through the circulation system 104 back to the pool 102 and may be various types of heaters 108. In one non-limiting example, the heater 108 may be a heat pump 112.

In some embodiments, the circulation system 104 includes one or more sensors 118 for measuring and/or detecting a parameter of the pool system 100 associated with performance of equipment of the circulation system 104 and/or other components of the pool system 100. As non-limiting examples, the one or more sensors 118 may detect or measure a characteristic of water of the pool system 100, a characteristic of equipment of the pool system 100, environmental data, and/or as otherwise desired. As non-limiting examples, the water characteristic may include but is not limited to a water temperature, salinity, pH, oxidative reduction potential (ORP), conductivity, turbidity, water level, and/or other information. As non-limiting examples, the characteristic of equipment of the pool system 100 may include an operational status (e.g., on, off, standby, etc.), an operational duration, energy usage, and/or otherwise. Other information may be obtained by the sensors 118 as desired.

In one non-limiting example, and as illustrated in FIG. 1, the one or more sensors 118 includes a temperature sensor 113 for measuring a water temperature of water of the pool system 100. In some embodiments, the temperature sensor 113 as the sensor 118 may be provided at any suitable location. In one non-limiting example, the temperature sensor 113 as the sensor 118 may be provided within the heater 108. In other embodiments, the temperature sensor 113 may be upstream and/or downstream from the heater 108 as desired.

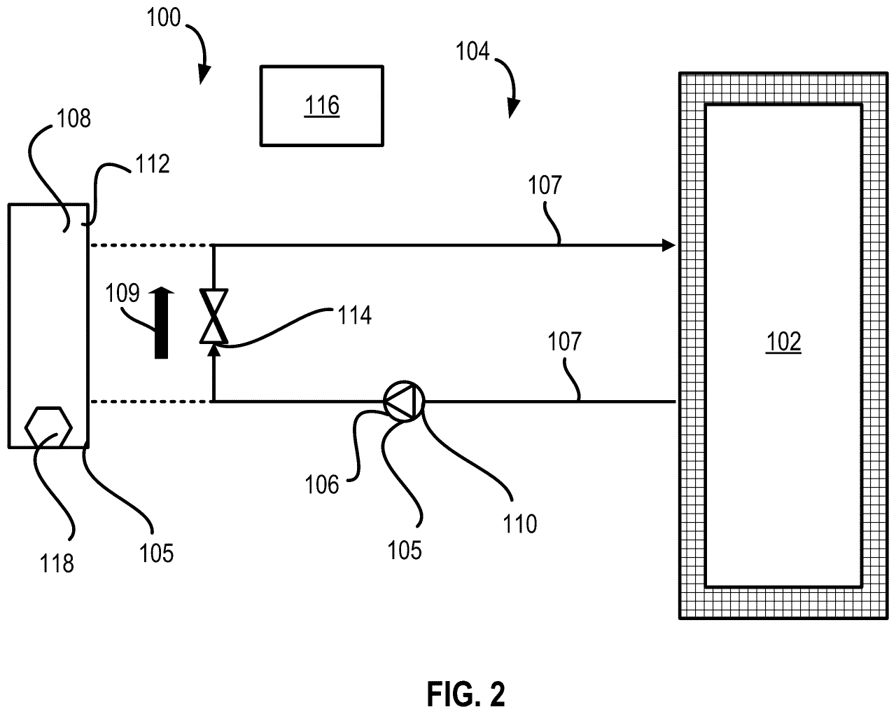

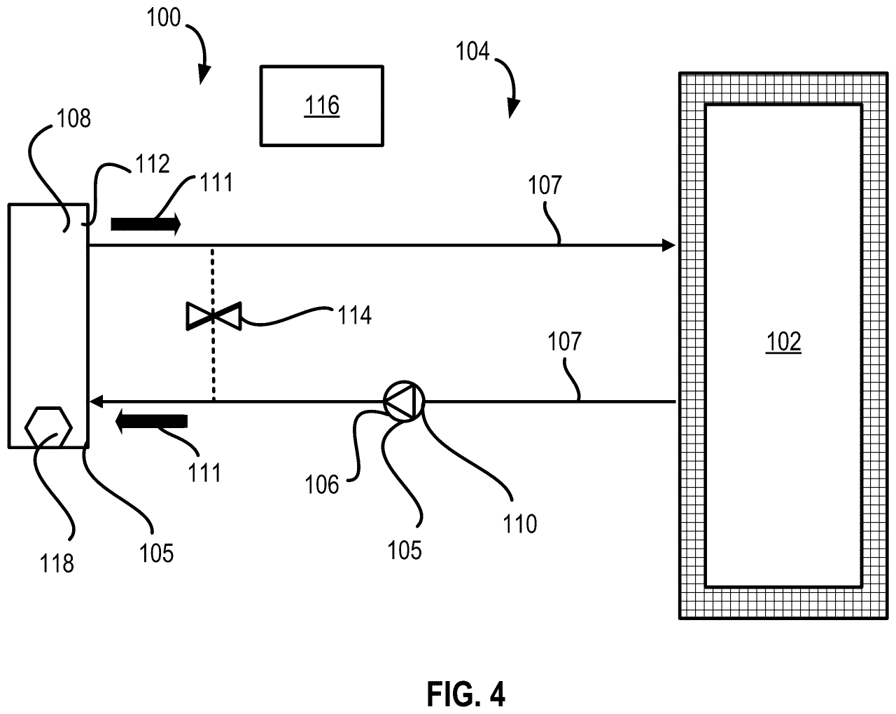

As illustrated in FIGS. 1, 2, and 4, the circulation system 104 includes one or more automatic valves 114 which may be selectively opened or closed such that water flowing through the circulation system 104 may selectively bypass one or more pieces of equipment 105. As non-limiting examples and as best illustrated in FIGS. 2 and 4, in some embodiments, the automatic valve 114 may be selectively controlled to be opened/in an open configuration such that a flow of water bypasses (or substantially bypasses) the heater 108 (represented by arrow 109 in FIG. 2) or to be closed/in a closed configuration such that a flow of water flows through the heater 108 (represented by arrows 111 in FIG. 4). In other embodiments, the automatic valve may be provided relative to other equipment, such as but not limited to a filtration pump, water treatment system, water feature, sand filtration system, and/or other piece of equipment. In certain embodiments, the automatic valve 114 may be provided downstream from the pump 106.

In some embodiments, and as illustrated in FIG. 2, the opened automatic valve 114 may cause all or substantially all of a flow of water to bypass the particular piece of equipment 105 (e.g., a flow path to the particular piece of equipment 105 is not opened). In other embodiments, the opened automatic valve 114 may cause less than all of the flow of water to bypass the particular piece of equipment 105, and a minimal flow of water to the piece of equipment 105 may be maintained. In such embodiments, in the open configuration, the flow of water bypassing the equipment 105 may be greater than the flow to the piece of equipment 105. As a non-limiting example and referring to FIG. 2, the opened automatic valve 114 may cause a majority (e.g., greater than 50%) of the flow of water to bypass the heater 108 while maintaining a minimal flow of water to the heater 108. In such embodiments, a sensor 118 such as the temperature sensor within the heater 108 may be able to obtain the temperature of water in the pool despite the heater 108 being bypassed. Thus, reference to the “closed” configuration does not require a complete bypass of the equipment 105.

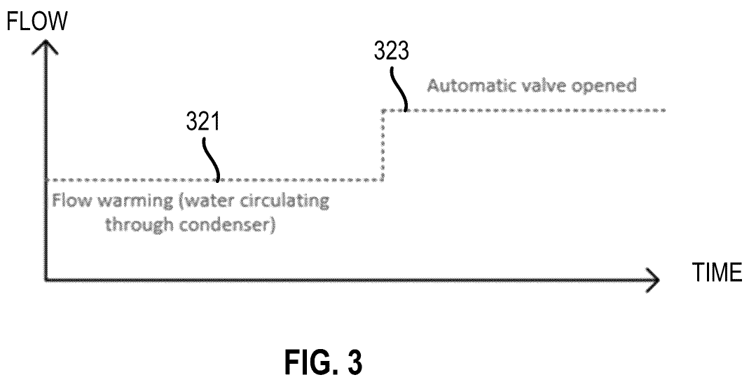

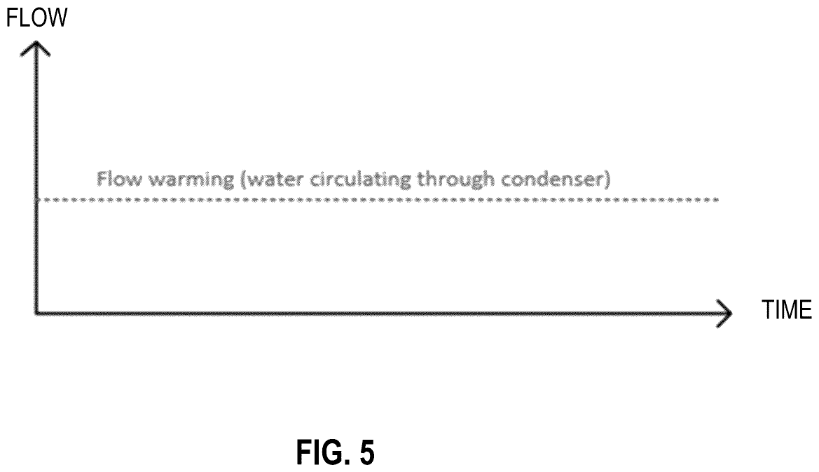

FIG. 3 is a graph illustrating a flow rate of water through the circulation system 104 before (portion 321) and after (portion 323) opening of the automatic valve 114, and FIG. 5 is a graph illustrating a flow rate of water through the circulation system 104 when the automatic valve 114 is closed. As illustrated by comparing the graphs in FIGS. 3 and 5, regardless of whether the complete flow of water or less than the complete flow of water bypasses a particular piece of equipment 105 when the automatic valve 114 is opened, in general, the flow rate of water through the pool system 100 is increased when the automatic valve 114 is opened (and assuming no other changes in operation of other equipment) due to water bypassing the heater 108 (or other piece of equipment). In some embodiments, and as discussed in detail below, the increased flow rate when the automatic valve 114 is opened may allow for optimized control of the flow of water and/or performance of other equipment 105. As discussed in more detail below, the automatic valve 114 may open to bypass the heater 108 when the water of the pool system 100 reaches a desired temperature.

Referring back to FIG. 1, optionally, the circulation system 104 includes one or more controllers 116 (processing unit and/or memory device) communicatively coupled to at least the automatic valve 114, the circulation system 104 and optionally the one or more sensors 118 using various communication techniques as desired. The processing unit of the controller may be various suitable processing devices or combinations of devices including but not limited to one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units, and/or a combination thereof. The one or more memory devices of the controller 116 may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

While illustrated as separate from equipment of the pool system 100 and/or the circulation system 104, the controller 116 may be provided as a component of one or more pieces of equipment. In certain embodiments, the controller 116 optionally includes an associated user interface, including but not limited to a human machine user interface, such that the controller 116 may obtain information from a user and/or provide information to the user via the user interface. When included, the user interface may be on the controller 116 itself or may be at a location remote from the controller 116 such as, but not limited to, another location within the pool system 100. Additionally, or alternatively, the controller 116 optionally may include various communication modules such that the controller 116 may receive and/or send information to a user device and/or other location as desired. Non-limiting examples of communication modules may include systems and mechanisms enabling wired communication and/or wireless communication (e.g., near field, cellular, Wi-Fi, Bluetooth®, Bluetooth Low Energy (BLE), low-power wide area network, cloud-based communication etc.). In one non-limiting example, the controller 116 may receive and/or send information to a user device via an application running on the user device.

In some embodiments, the controller 116 may control the automatic valve 114 to be open (and thus bypass equipment) based on a parameter associated with performance of the equipment reaching or exceeding a threshold or target value. As a non-limiting example, the temperature of the water may be monitored based on data from the one or more sensors 118, and the controller 116 may open the automatic valve 114 to bypass the heater 108 based on the measured temperature reaching (or exceeding) a target temperature because further heating of the water is not required. As a further non-limiting example, the turbidity and/or chemical balance of the water may be monitored based on data from the one or more sensors 118, and the controller 116 may open the automatic valve 114 to bypass a sand filtration system and/or a water treatment system based on the measured turbidity and/or chemical balance being at a target level. Conversely, the controller 116 may control the automatic valve 114 to be closed based on a parameter associated with performance of the equipment not being at the threshold or target value. As a non-limiting example, the controller 116 may close the automatic valve 114 based on the measured temperature being less than the target temperature such that water is directed to the heater 108, which may continue to heat the water until it reaches the target value.

In certain embodiments, the controller 116 may further optimize the flow of water when the automatic valve 114 is opened. Referring back to FIGS. 2-5, because the flow rate is increased when the automatic valve 114 is open (because the water is bypassing a piece of equipment such as a heater), the controller 116 may control performance of other equipment 105 to maintain the same flow rate as when the automatic valve 114 is closed and/or optimize performance of other equipment 105. As non-limiting examples, when the automatic valve 114 is open, the controller 116 may reduce the water filtration time within the pump 106 and/or a filter while maintaining the pump speed, and/or the controller 116 may reduce the speed of the pump 106. Such control may provide energy and cost savings by reducing filtration time and/or reducing the speed of the pump.

Additionally, or alternatively, when pressure inside the heat pump 112 increases, an operating temperature of the heat pump 112 also increases. Thus, defrosting the heater can be postponed or reduced, and ice formation can be prevented. Decreasing water flow within the heat pump 112, for example by opening the automatic valve 114, can increase a pressure of refrigerant in the heat pump 112, which can increase the operating temperature of the heat pump 112 and reduce icing within the heat pump 112.

As a further non-limiting example, the automatic valve 114 may be provided relative to a water feature such as but not limited to a fountain such that water selectively flows to or bypasses the fountain. In such embodiments, the controller 116 may open the automatic valve 114 to bypass the fountain based on input from a user, a duration of flow to the fountain meeting a threshold duration, energy usage of the fountain during a time interval, an operational status of other equipment (e.g., the heat pump 112 being on, a sanitation system being active, etc.), combinations thereof, and/or as otherwise desired. Additionally, or alternatively, the controller 116 may close the automatic valve 114 to direct water to the fountain based on input from a user, a duration of flow bypassing the fountain meeting a threshold duration, energy usage of the overall pool system 100 being below a threshold value during a time interval, an operational status of other equipment (e.g., the heat pump 112 being off, a sanitation system being off, etc.), combinations thereof, and/or as otherwise desired.

As another non-limiting example, the controller 116 may control the automatic valve 114 to optimize performance of equipment 105. As non-limiting examples, because the flow rate is increased when the automatic valve 114 is open, the controller 116 may reduce the water filtration time within the pump 106 and/or a filter while maintaining a pump speed, the controller 116 may reduce the speed of the pump 106 while maintaining a water filtration time. Such control may provide energy and cost savings by reducing filtration time and/or reducing the speed of the pump. As further non-limiting examples, the controller 116 may reduce heating performance of the heat pump 108 when the automatic valve 114 is open. As a further non-limiting example, d the controller 116 may open the automatic valve 114 to bypass a sand filtration system and/or a water treatment system based on a water characteristic being at a target level, thereby reducing the working time and associated energy of the sand filtration system.

As another non-limiting example, the controller 116 may control one or more automatic valves 114 for a backwashing operation. As non-limiting examples, the controller 116 may control the automatic valves 114 to control the direction of flow through a filtration system, optionally initiating the backwashing operation responsive to a detected pressure, turbidity, and/or other characteristic as desired.

As yet another non-limiting example, the controller 116 may control one or more automatic valves 114 based on a plurality of inputs/outputs. As non-limiting examples, the user may provide a desired energy usage level for the pool system 100, and the controller 116 may control one or more automatic valves 114 to selectively bypass or enable flow to various combinations of equipment 105 based on detected energy usage. As a further non-limiting example, the user may provide both a desired energy usage level and a desired operational status (e.g., activation of the heat pump 108), and in such embodiments, the controller 116 may control one or more automatic valves to selectively bypass or enable flow to various combinations of equipment 105 based on detected energy usage and while the heat pump 108 is operational. Various other controls may be realized using the systems described herein, and the aforementioned examples should not be considered limiting.

Exemplary concepts or combinations of features of the invention may include:
A. A method of optimizing a flow of water of a swimming pool or spa, the method comprising:
   i. monitoring a temperature of water of the swimming pool or spa relative to a target temperature;
   ii. activating a bypass valve such that water bypasses a heat pump for the swimming pool or spa based on the temperature of the water reaching or exceeding the target temperature; and
   iii. controlling a filtration pump upon activation of the bypass valve by reducing a water filtration time or reducing a speed of the filtration pump.
B. A method of optimizing a flow of water of a swimming pool or spa, the method comprising:
   i. monitoring a temperature of water of the swimming pool or spa relative to a target temperature;
   ii. activating a bypass valve such that water bypasses a heat pump for the swimming pool or spa based on the temperature of the water reaching or exceeding the target temperature; and
   iii. controlling a filtration pump upon activation of the bypass valve to reduce energy consumption.
C. A method of optimizing a flow of water of a swimming pool or spa, the method comprising:
   i. receiving a flow rate of water through a circulation system and when a heat pump is heating the water;
   ii. monitoring a temperature of the water of the swimming pool or spa relative to a target temperature;
   iii. activating a bypass valve such that the water bypasses the heat pump for the swimming pool or spa based on the temperature of the water reaching or exceeding the target temperature; and
   iv. controlling a filtration pump upon activation of the bypass valve to maintain the flow rate through the circulation system.
D. The method of any preceding or subsequent statement or combination of statements, wherein controlling the filtration pump comprises reducing a water filtration time and/or reducing a speed of the filtration pump.
E. The method of any preceding or subsequent statement or combination of statements, wherein the bypass valve is within the heat pump or outside of the heat pump.
F. A method of optimizing a flow of water of a swimming pool or spa, the method comprising:
   i. monitoring a parameter associated with performance of equipment of the swimming pool or spa and relative to a target for the parameter;
   ii. activating a bypass valve such that water bypasses the equipment based on the parameter reaching or exceeding the target; and
   iii. controlling a filtration pump upon activation of the bypass valve by reducing a water filtration time or reducing a speed of the filtration pump.
G. A method of optimizing a flow of water of a swimming pool or spa, the method comprising:
   i. monitoring a parameter associated with performance of equipment of the swimming pool or spa and relative to a target for the parameter;
   ii. activating a bypass valve such that water bypasses the equipment based on the parameter reaching or exceeding the target; and
   iii. controlling a pump and/or a filtration system upon activation of the bypass valve to reduce energy consumption.
H. A method of optimizing a flow of water of a swimming pool or spa, the method comprising:
   i. monitoring a parameter associated with performance of equipment of the swimming pool or spa and relative to a target for the parameter;
   ii. activating a bypass valve such that water bypasses the equipment based on the parameter reaching or exceeding the target; and
   iii. controlling a pump and/or a filtration system upon activation of the bypass valve to maintain a flow rate through the circulation system.
I. The method of any preceding or subsequent statement or combination of statements, wherein controlling the pump and/or filtration system comprises reducing a water filtration time and/or reducing a speed of the pump.
J. The method of any preceding or subsequent statement or combination of statements, wherein the equipment comprises at least one of a heater, a sand filtration system, a water feature, a water treatment system, a filtration pump, a heat pump, or other equipment as desired.
K. The method of any preceding or subsequent statement or combination of statements, wherein the bypass valve is automatically activated.
L. A method of optimizing a flow of water of a swimming pool or spa, the method comprising:
   i. directing water to a heat pump;
   ii. monitoring a temperature of water of the swimming pool or spa relative to a target temperature using a sensor within the heat pump; and
   iii. activating a bypass valve based on the temperature of the water reaching or exceeding the target temperature, wherein activating the bypass valve causes a majority of a flow of water to bypass the heat pump while maintaining a minimum flow of water to the heat pump.
M. A method of controlling ice formation on a heat pump, the method comprising increasing a pressure of refrigerant of the heat pump by decreasing a flow of water through the heat pump, wherein decreasing the flow of water comprises controlling a bypass valve for the heat pump.
N. A pool system comprising a heat pump and an automatic valve, wherein the automatic valve is actuatable in response to a temperature of water of the water-containing vessel to adjust a flow of water through the heat pump.
O. A pool system comprising a heat pump, a temperature sensor within the heat pump, and an automatic valve, wherein the automatic valve is controllable to optimize flow of water through the heat pump to optimize energy consumption of the pool system based at least in part on temperature data about the water gathered by the temperature sensor.
P. A non-transitory computer readable storage medium comprising a plurality of instructions executable by one or more processors, which, when executed on the one or more processors, cause the one or more processors to perform actions including any preceding or subsequent statement or combination of statements.
Q. A method of optimizing a flow of water of a swimming pool or spa, the method comprising: monitoring a parameter associated with performance of a first piece of equipment of the swimming pool or spa and relative to a target for the parameter; activating a bypass valve such that water bypasses the first piece equipment based on the parameter reaching or exceeding the target; and controlling operation of a second piece of equipment of a circulation system responsive to activation of the bypass valve.
R. The method any preceding or subsequent statement or combination of statements, wherein the second piece of equipment of the circulation system comprises a pump and/or a filtration system, and wherein controlling operation of the equipment is configured to reduce energy consumption and/or maintain a flow rate through a circulation system.
S. The method any preceding or subsequent statement or combination of statements, wherein the parameter is a temperature of water of the swimming pool or spa and wherein the first piece of equipment comprises a heat pump, and activating the bypass valve is based on the temperature of the water reaching or exceeding a target temperature.
T. The method any preceding or subsequent statement or combination of statements, wherein controlling operation of the second piece equipment is configured to maintain a flow rate of water through the circulation system and/or reduce energy consumption.
U. The method any preceding or subsequent statement or combination of statements, wherein controlling the second piece of equipment comprises controlling a filtration pump by reducing a speed of the filtration pump and/or reducing a water filtration time in the filtration pump.
V. The method any preceding or subsequent statement or combination of statements, wherein the first piece of equipment is a heat pump, wherein the method further comprises receiving a flow rate of water through the circulation system and when the heat pump is heating the water, and wherein controlling operation of equipment comprises controlling a filtration pump to maintain the flow rate through the circulation system.
W. The method any preceding or subsequent statement or combination of statements, wherein activating the bypass valve such that water bypasses the first piece of equipment comprises maintaining a minimum flow of water to the first piece of equipment.
X. The method any preceding or subsequent statement or combination of statements, wherein the first piece of equipment comprises at least one of a heater, a sand filtration system, a water feature, or a water treatment system.
Y. A non-transitory computer readable storage medium comprising a plurality of instructions executable by one or more processors, the plurality of instructions comprising instructions which, when executed by the one or more processors, cause the one or more processors to perform actions comprising: monitoring a parameter associated with performance of a first piece of equipment of the swimming pool or spa and relative to a target for the parameter; activating a bypass valve such that water bypasses the first piece equipment based on the parameter reaching or exceeding the target; and controlling operation of a second piece of equipment of a circulation system responsive to activation of the bypass valve
Z. The non-transitory computer readable storage medium any preceding or subsequent statement or combination of statements, wherein the first piece of equipment comprises at least one of a heater, a sand filtration system, a water feature, a heat pump, or a water treatment system, and wherein the second piece of equipment comprises a filtration pump.
AA. The non-transitory computer readable storage medium any preceding or subsequent statement or combination of statements, wherein the instructions for controlling operation of the second piece of equipment comprise instructions controlling operation of the second piece equipment to maintain a flow rate of water through the circulation system and/or reduce energy consumption.
BB. A pool system comprising a circulation system, the circulation system comprising: a bypass valve for controlling a flow of water relative to a first piece of equipment; and a controller configured to: receive sensor data from at least one sensor, the sensor data comprising a parameter associated with performance of the first piece of equipment of the pool system; compare the parameter relative to a target for the parameter; responsive to the parameter reaching or exceeding the target, activating the bypass valve such that the flow of water bypassing the first piece of equipment is greater than the flow of water to the first piece of equipment; and responsive to activating the bypass valve, controlling operation of a second piece of equipment of the circulation system.
CC. The pool system any preceding or subsequent statement or combination of statements, wherein the second piece of equipment comprises at least one of a pump or a filtration system, and wherein controlling operation of the second piece of equipment is configured to reduce energy consumption and/or maintain a flow rate through the circulation system.
DD. The pool system any preceding or subsequent statement or combination of statements, further comprising the at least one sensor configured to detect the parameter associated with performance of the first piece of equipment.
EE. The pool system any preceding or subsequent statement or combination of statements, wherein the at least one sensor is a temperature sensor, and wherein the first piece of equipment is a heat pump.
FF. The pool system any preceding or subsequent statement or combination of statements, wherein the bypass valve is within the first piece of equipment.
GG. The pool system any preceding or subsequent statement or combination of statements, wherein the first piece of equipment comprises at least one of a heater, a sand filtration system, a water feature, or a water treatment system.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with swimming pools, persons skilled in the relevant field will recognize that the present invention conceivably could be employed in connection with other objects and in other manners. Finally, references to “pools” and “swimming pools” herein may also refer to spas or other water containing vessels used for recreation, training, or therapy.

That which is claimed:

1. A method of optimizing a flow of water of a swimming pool or spa, the method comprising:
monitoring a parameter associated with performance of a first piece of equipment of the swimming pool or spa and relative to a target for the parameter;
activating a bypass valve such that water bypasses the first piece equipment based on the parameter reaching or exceeding the target; and
controlling operation of a second piece of equipment of a circulation system responsive to activation of the bypass valve.

2. The method of claim 1, wherein the second piece of equipment of the circulation system comprises a pump and/or a filtration system, and wherein controlling operation of the equipment is configured to reduce energy consumption and/or maintain a flow rate through a circulation system.

3. The method of claim 1, wherein the parameter is a temperature of water of the swimming pool or spa and wherein the first piece of equipment comprises a heat pump, and activating the bypass valve is based on the temperature of the water reaching or exceeding a target temperature.

4. The method of claim 1, wherein controlling operation of the second piece equipment is configured to maintain a flow rate of water through the circulation system and/or reduce energy consumption.

5. The method of claim 4, wherein controlling the second piece of equipment comprises controlling a filtration pump by reducing a speed of the filtration pump.

6. The method of claim 4, wherein controlling the second piece of equipment comprises reducing a water filtration time in a filtration pump.

7. The method of claim 1, wherein the first piece of equipment is a heat pump, wherein the method further comprises receiving a flow rate of water through the circulation system and when the heat pump is heating the water, and wherein controlling operation of equipment comprises controlling a filtration pump to maintain the flow rate through the circulation system.

8. The method of claim 1, wherein the bypass valve is within a heat pump.

9. The method of claim 1, wherein the bypass valve is outside of a heat pump.

10. The method of claim 1, wherein activating the bypass valve such that water bypasses the first piece of equipment comprises maintaining a minimum flow of water to the first piece of equipment.

11. The method of claim 1, wherein the first piece of equipment comprises at least one of a heater, a sand filtration system, a water feature, or a water treatment system.

12. A non-transitory computer readable storage medium comprising a plurality of instructions executable by one or more processors, the plurality of instructions comprising instructions which, when executed by the one or more processors, cause the one or more processors to perform actions comprising:
monitoring a parameter associated with performance of a first piece of equipment of a swimming pool or spa and relative to a target for the parameter;
activating a bypass valve such that water bypasses the first piece equipment based on the parameter reaching or exceeding the target; and
controlling operation of a second piece of equipment of a circulation system responsive to activation of the bypass valve.

13. The non-transitory computer readable storage medium of claim 12, wherein the first piece of equipment comprises at least one of a heater, a sand filtration system, a water feature, a heat pump, or a water treatment system, and wherein the second piece of equipment comprises a filtration pump.

14. The non-transitory computer readable storage medium of claim 12, wherein the instructions for controlling operation of the second piece of equipment comprise instructions controlling operation of the second piece equipment to maintain a flow rate of water through the circulation system and/or reduce energy consumption.

15. A pool system comprising a circulation system, the circulation system comprising:
a bypass valve for controlling a flow of water relative to a first piece of equipment; and
a controller configured to:
receive sensor data from at least one sensor, the sensor data comprising a parameter associated with performance of the first piece of equipment of the pool system;
compare the parameter relative to a target for the parameter;
responsive to the parameter reaching or exceeding the target, activating the bypass valve such that the flow of water bypassing the first piece of equipment is greater than the flow of water to the first piece of equipment; and
responsive to activating the bypass valve, controlling operation of a second piece of equipment of the circulation system.

16. The pool system of claim 15, wherein the second piece of equipment comprises at least one of a pump or a filtration system, and wherein controlling operation of the second piece of equipment is configured to reduce energy consumption and/or maintain a flow rate through the circulation system.

17. The pool system of claim 15, further comprising the at least one sensor configured to detect the parameter associated with performance of the first piece of equipment.

18. The pool system of claim 17, wherein the at least one sensor is a temperature sensor, and wherein the first piece of equipment is a heat pump.

19. The pool system of claim 15, wherein the bypass valve is within the first piece of equipment.

20. The pool system of claim 15, wherein the first piece of equipment comprises at least one of a heater, a sand filtration system, a water feature, or a water treatment system.
